(19) United States
(12) Patent Application Publication
(10) Pub. No.: US 2023/0021549 A1
(43) Pub. Date: Jan. 26, 2023

(54) SYSTEMS AND METHODS OF PHASE AND POLARIZATION SINGULARITY ENGINEERING

(71) Applicant: PRESIDENT AND FELLOWS OF HARVARD COLLEGE, Cambridge, MA (US)

(72) Inventors: Soon Wei Daniel LIM, Cambridge, MA (US); Joon-Suh PARK, Cambridge, MA (US); Maryna Leonidivna MERETSKA, Cambridge, MA (US); Federico CAPASSO, Cambridge, MA (US); Ahmed Hassen Dorrah, Cambridge, MA (US)

(73) Assignee: PRESIDENT AND FELLOWS OF HARVARD COLLEGE, Cambridge, MA (US)

(21) Appl. No.: 17/579,460

(22) Filed: Jan. 19, 2022

Related U.S. Application Data
(60) Provisional application No. 63/140,260, filed on Jan. 22, 2021.

(51) Int. Cl. G06F 17/14; G06F 17/16; G06F 17/15

(52) U.S. Cl. CPC G06F 17/148; G06F 17/16; G06F 17/156

(57) ABSTRACT

Disclosed is a method of generating a functional singularity at a point or collection of points. The method may include determining a relationship between one or more parameters associated with a physical structure and a spatial gradient of field values of at least one of electromagnetic energy, sound energy, particle beam, or water waves manipulated by the physical structure, configuring, according to the relationship, the spatial gradient of field values to represent a functional singularity at a point, performing backpropagation using the spatial gradient of field values to obtain design parameters corresponding to values for the one or more parameters that achieve the functional singularity at the point, and producing a physical structure having the design parameters.

### CROSS-REFERENCE TO RELATED APPLICATIONS

This application claims the benefit of and priority to U.S. Provisional Patent Application No. 63/140,260, filed Jan. 22, 2021, the contents of which is incorporated by reference herein in its entirety for all purposes.

### STATEMENT OF FEDERALLY SPONSORED RESEARCH OR DEVELOPMENT

This invention was made with government support under 2025158 awarded by the National Science Foundation, and FA9550-19-1-0135 awarded by the U.S. Air Force Office of Scientific Research. The government has certain rights in the invention.

### BACKGROUND

Optical phase singularities are positions of zero field value in a complex scalar field. For example, regions of darkness surrounded by light. Singularities may be ubiquitous in complex wave systems and are accompanied by extremely rapid phase variation nearby. The most systematically studied subclass of singular fields is optical vortices: beams with helically wound wavefronts which carry orbital angular momentum and are accompanied by a linear (1D) singularity along the optical axis.

### SUMMARY

One embodiment of the present disclosure is a method of generating a functional singularity at a point or collection of points including determining a relationship between one or more parameters associated with a physical structure and a spatial gradient of field values of at least one of electromagnetic energy, sound energy, charged or uncharged particle beam, or water waves manipulated by the physical structure, configuring, according to the relationship, the spatial gradient of field values to represent a functional singularity at a point, performing backpropagation using the spatial gradient of field values to obtain design parameters corresponding to values for the one or more parameters that achieve the functional singularity at the point, and producing a physical structure having the design parameters.

In some embodiments, the functional singularity includes a phase singularity in one or more field components. In some embodiments, the field values are associated with light manipulated by the physical structure and wherein the functional singularity includes a polarization singularity. In some embodiments, the polarization singularity is in an azimuth of a transverse polarization in a paraxial field. In some embodiments, the polarization singularity is in an ellipticity angle of a transverse polarization in a paraxial field. In some embodiments, the physical structure includes a metasurface. In some embodiments, the physical structure includes a spatially-variant phase plate. In some embodiments, the physical structure includes a spatial light modulator (SLM). In some embodiments, the physical structure includes a spatially-variant waveplate. In some embodiments, the design parameters include a plurality of at least one of nanopillar diameter, height, or width values. In some embodiments, the design parameters include a plurality of nanostructure rotation angles or spatial displacements. In some embodiments, the point includes an isolated 0-dimensional position in 3-dimensional space. In some embodiments, a collection of points forms one or more 1-dimensional lines in 3-dimensional space. In some embodiments, a collection of points forms one or more 2-dimensional surfaces in 3-dimensional space. In some embodiments, a collection of points forms one or more 3-dimensional volumes in 3-dimensional space. In some embodiments, configuring the spatial gradient of field values includes performing gradient descent optimization. In some embodiments, the functional singularity is associated with a maximized value of the spatial gradient of field values at the point. In some embodiments, the functional singularity is associated with a minimized value of the field value magnitude at the point. In some embodiments, the spatial gradient of field values at the point is oriented perpendicular to the physical structure. In some embodiments, the relationship between the one or more parameters associated with the physical structure and the spatial gradient of field values includes a Green's function for wave propagation. In some embodiments, the relationship between the one or more parameters associated with the physical structure and the spatial gradient of field values includes a spatial Fourier transform. In some embodiments, the physical structure includes an acoustic transducer. In some embodiments, the physical structure includes a shaped magnetic field for deflecting charged particles. In some embodiments, the physical structure includes a shaped reflector or attenuator. In some embodiments, the physical structure includes at least one of a water pump or pneumatic actuator.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1 is a block diagram illustrating a system for generating phase and polarization singularities, according to an example embodiment;

FIGS. 2A-2H are a number of diagrams illustrating optical singularities, according to several example embodiments;

FIGS. 3A-3D are a number of diagrams illustrating isosurfaces of optical singularities, according to several example embodiments;

FIGS. 4A-4H are a number of diagrams illustrating an engineered heart-shaped optical phase singularity, according to several example embodiments;

FIG. 5A includes images of a metasurface designed by the system of FIG. 1, according to an example embodiment;

FIG. 5B is a block diagram illustrating a setup for characterizing an optical phase singularity, according to an example embodiment;

FIG. 5C is a diagram illustrating multiple-intensity reconstruction using the setup of FIG. 5B, according to an example embodiment;

FIGS. 6A-6F are a number of diagrams illustrating an engineered heart-shaped optical polarization singularity, according to several example embodiments;

FIG. 7A includes images of a polarization-sensitive metasurface designed by the system of FIG. 1, according to an example embodiment;

FIG. 7B is a block diagram illustrating a setup for characterizing an optical polarization singularity, according to an example embodiment;

FIGS. 8A-8E are a number of diagrams illustrating characteristics of a blue-detuned trap array generated by the system of FIG. 1, according to several example embodiments; and

FIG. 9 is a method of generating a physical structure to create a functional singularity, according to an example embodiment.

### DETAILED DESCRIPTION

Optical phase singularities are positions of zero field value in a complex scalar field—regions of darkness surrounded by light. These singularities may be ubiquitous in complex wave systems and may arise due to extremely rapid or discontinuous phase variation in a given light field. In some embodiments, this is encountered in beams with orbital angular momentum (OAM), which may exhibit a linear singularity along the optical axis, around which the wavefront (and thus the Poynting vector) swirls and forms an optical vortex. Phase structures of this nature, and their associated singularities, have attracted much attention owing to the non-intuitive behavior they can imbue on the surrounding light field. As a non-limiting example, superoscillations, whereby a bandlimited signal exhibits rapid spatial variation that is arbitrarily larger than its maximum Fourier component, may occur by virtue of nearby singularities. In various embodiments, phase singularities exhibit fundamentally different topologies as compared to bright regions of the field and obey different constraints. As a non-limiting example, focusing a beam of light is usually constrained by the diffraction limit (e.g., it may be difficult to focus light into a small region or into a sharp angle, etc.). There is no such diffraction limit for dark (e.g., one may make phase singularities arbitrarily localized and measure their locations with deeply subwavelength precision, limited only by the signal-to-noise ratio of the measuring apparatus, etc.). Indeed, measuring an intensity minimum may be far more precise than measuring the displacements of finite-width beams of light. This may enable a host of applications which rely on the small size and high location precision of singularities. For instance, molecular scale imaging, enabled via the MINFLUX technique, may infer the position of a fluorescent particle from the spot of minimum emission when the particle is illuminated with a doughnut-shaped pump beam with zero on-axis intensity. In some embodiments, the precise position of singularities may be used to create a subwavelength ruler that can resolve displacements to 1/800 of the light wavelength or greater.

Optical phase singularities are largely synonymous with one-dimensional (1D) singularity lines, such as those on the optical axis of OAM beams. However, the interchangeability of “vortex” beams singular light produces a misconception that all optical singularities look like 1D phase singularities. In various embodiments, 1D line structures may be observed as they are stable with respect to small perturbations to the scalar field. In some embodiments, other classes of singularities such as point (zero-dimensional) and surface (two-dimensional) singular structures also exist, where the singularity can take the form of a single point or a continuous surface, respectively. In various embodiments, such structures may be unstable in the sense that a small perturbation added to the field can easily deform its singular region, reducing it to a collection of zero or more stable 1D singularities. These singular structures may be observed in systems with high symmetry, such as the radial nodes in cylindrically symmetric Bessel beams.

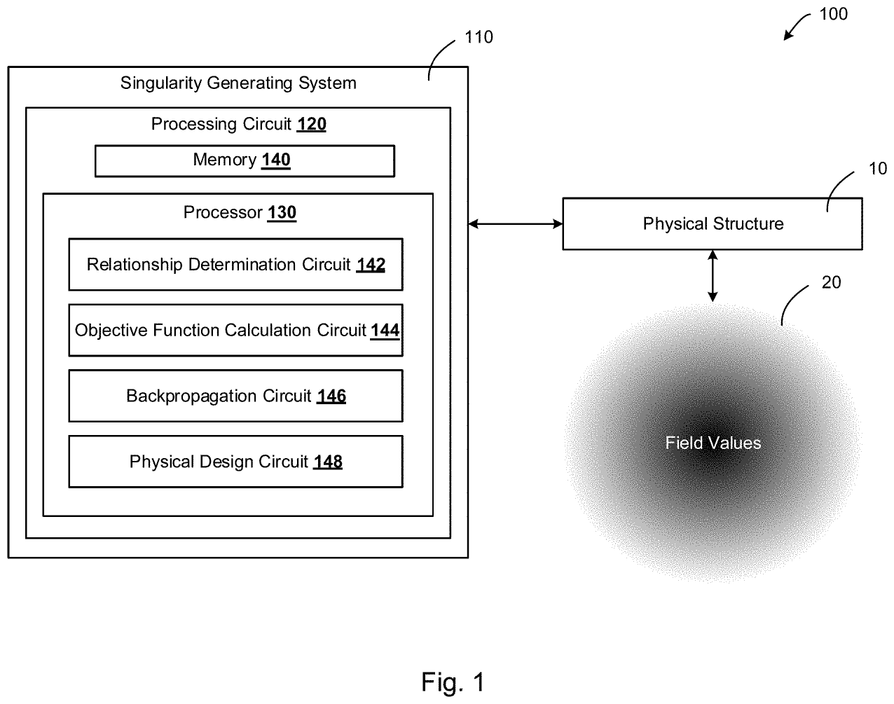

Turning now to FIG. 1, system 100 for generating singularities is shown, according to an example embodiment. In various embodiments, system 100 may generate/provide design parameters for constructing and/or operating a physical structure to achieve a functional singularity. For example, system 100 may generate/provide/determine a plurality of nanopillar diameters for a nanostructure to generate/define an optical singularity. As another example, system 100 may generate/provide/determine operational parameters for a plurality of actuators to generate a water wave singularity. As another example, system 100 may generate/provide/determine the pixelated phase and/or amplitude profile to be displayed in one or more spatial light modulators. In various embodiments, the singularities generated by system 100 are arbitrary in size and/or shape. For example, system 100 may generate/establish/define a singularity at a point and/or may combine/aggregate a number of point singularities to achieve an extended singularity in a shape of an arbitrary object. In various embodiments, system 100 determines a relationship (e.g., mathematical, linking, descriptive, etc.) between design parameters and field values or spatial gradients of field values associated with one or more points in space. For example, system 100 may determine piecewise continuous functions that link/relate a plurality of nanopillar widths to a spatial gradient of field values associated with light. In various embodiments, system 100 may use the information contained in the aforementioned relationship to generate/determine a suitable set of design parameters associated with a desired field characteristic such as the shape of a functional singularity.

System 100 is shown to include singularity generating system 110 which may generate/determine/provide design parameters and/or operational parameters for physical structure 10 which may interact with propagating or evanescent fields to achieve/establish a functional singularity in field values 20. In various embodiments, the propagating energy may include electromagnetic energy, sound energy, particle beams, and/or water waves. Physical structure 10 may include a metasurface, a spatial light modulator (SLM), a spatially variant waveplate, an acoustic transducer, a water pump, a pneumatic actuator, magnetic fields, shaped reflectors, shaped attenuators, and/or the like. In various embodiments, physical structure 10 may generate/establish fixed functional singularities (e.g., functional singularities that are the result of static design parameters, etc.). Additionally or alternatively, physical structure 10 may generate dynamic functional singularities (e.g., functional singularities that may be changed based on dynamically controlling a physical structure such as changing a voltage applied to a SLM, etc.). It should be understood that physical structure 10 may generate 0D, 1D, 2D, and/or 3D functional singularities in the fields values 20.

Singularity generating system 110 may include processing circuit 120 having processor 130 and memory 140. Processor 130 may be a general purpose or specific purpose processor, an application specific integrated circuit (ASIC), one or more field programmable gate arrays (FPGAs), a group of processing components, or other suitable processing components. Processor 130 may be configured to execute computer code or instructions stored in memory 140 or received from other computer readable media (e.g., CDROM, network storage, a remote server, etc.).

Memory 140 may include one or more devices (e.g., memory units, memory devices, storage devices, or other computer-readable media) for storing data and/or computer code for completing and/or facilitating the various processes described in the present disclosure. Memory 140 may include random access memory (RAM), read-only memory (ROM), hard drive storage, temporary storage, non-volatile memory, flash memory, optical memory, or any other suitable memory for storing software objects and/or computer instructions. Memory 140 may include database components, object code components, script components, or any other type of information structure for supporting the various activities and information structures described in the present disclosure. Memory 140 may be communicably connected to processor 130 via processing circuit 120 and may include computer code for executing (e.g., by processor 130) one or more of the processes described herein.

Processor 130 may include relationship determination circuit 142, objective function calculation circuit 144, backpropagation circuit 146, and physical design circuit 148. In some embodiments, one or more of relationship determination circuit 142, objective function calculation circuit 144, backpropagation circuit 146, and/or physical design circuit 148 are embodied as computer-executable instructions stored in memory 140. Relationship determination circuit 142 may determine a relationship (e.g., mathematical relationship, descriptive relationship, etc.) between parameters associated with physical structure 10 and field values 20 based on one or more theoretical models of the physical system comprising the physical structure 10 and field values 20. For example, relationship determination circuit 142 may determine a relationship between metasurface design parameters and complex field values and/or objective function values (e.g., through the theoretical model of Maxwell's equations). In some embodiments, relationship determination circuit 142 determines one or more piecewise continuous mathematical operations that link the parameters associated with physical structure 10 and field values 20. Relationship determination is described in greater detail below. In some embodiments, the mathematical operations performed by relationship determination circuit 142 are stored as a computational tree in memory 140.

Objective function calculation circuit 144 may convert the modeled field values or field gradients from relationship determination circuit 142 into one real number to be optimized. For example, objective function calculation circuit 144 may calculate the minimum field phase gradient from a list of field phase gradient values provided by relationship determination circuit 142, since the point with the minimum field phase gradient may represent the worst-performing point that requires iterative improvement. In some embodiments, objective function calculation circuit 144 may accept as input modeled field values or field gradients from a plurality of relationship determination circuits 142, each relationship determinization circuit 142 representing a different configuration of physical structure 10 or incident evanescent or propagating fields that interact with physical structure 10. For example, objective function calculation circuit 144 may accept as input field values from one relationship determination circuit 142 representing green light incident on physical structure 10, and from another relationship determination circuit 142 representing red light incident on physical structure 10 (e.g., to control the behavior of physical structure 10 under illumination of two light colors, etc.). In various embodiments, objective function calculation circuit 144 returns one real number as output. In some embodiments, the mathematical operations performed by objective function calculation circuit 144 are stored as a computational tree in memory 140.

Backpropagation circuit 146 may perform backpropagation using the stored computational trees constructed by relationship determination circuit 142 and/or objective function calculation circuit 144. In various embodiments, backpropagation circuit 146 traverses a computational tree to determine a first-order or higher-order derivative of the real output from objective function calculation circuit 144 with respect to one or more parameters associated with physical structure 10. Backpropagation is described in greater detail below.

Physical design circuit 148 may generate and/or optimize physical design and/or operational parameters for physical structure 10 based on the gradient information provided by backpropagation circuit 146. For example, physical design circuit 148 may optimize physical design parameters such as nanopillar diameters, orientations, rotation angles, shapes, separations/gaps, heights, and/or widths associated with a nanostructure based on backpropagation performed by backpropagation circuit 146. In various embodiments, physical design circuit 148 may facilitate producing physical structure 10 having characteristics to generate a functional singularity as modeled by objective function calculation circuit 144. In some embodiments, physical design circuit 148 updates the input and intermediate values for one or more of relationship determination circuit 142, objective function calculation circuit 144, and/or backpropagation circuit 146 to obtain updated gradient information used to iteratively improve the behavior of physical structure 10. Generating physical design parameters and producing a physical structure is described in greater detail below.

Referring now generally to the figures, system 100 may offer many benefits over existing systems and/or methods. Traditional systems and methods of generating singularities such as optical singularities may be incapable of generating singularities limited to a point in space. For example, a conventional system may generate a line singularity such as that associated with the optical axis of a beam with orbital angular momentum but may be unable to generate a singularity at only a specific point on the line. Moreover, traditional systems and methods may be incapable of generating singularities associated with zero field value such as one or more optically dark points. However, system 100 of the present disclosure may generate phase and/or polarization singularities representing dark spots at arbitrary points. Furthermore, some traditional systems may rely on finite difference methods to compute the objective function gradient that are more computationally demanding than the algorithmic differentiation (backpropagation) as performed by system 100. Moreover, conventional systems that rely on finite difference methods may be more susceptible to errors than system 100 described herein (e.g., estimating a derivative near singularities where the phase gradients are diverging is highly susceptible to errors using a finite difference method, particularly when it pertains to the a periodic phase, etc.). Furthermore, dark regions generated/produced by system 100 may be generated with greater contrast and fidelity than that attained through traditional systems such as traditional computer-generated holography.

System 100 may facilitate improvements in various technologies. For example, system 100 may generate custom phase plates and/or metasurfaces for singular point-spread-functions in fluorescent microscopy. As another example, system 100 may facilitate adaptive optics for astronomical and/or military telescopes that allow selective enhancement and suppression of light sources in an image. In various embodiments, system 100 may facilitate design of devices using superoscillations. For example, system 100 may facilitate placement of dark singular features around a position to “squeeze” light into a subwavelength space.

In various embodiments, system 100 may facilitate advances in remote sensing. For example, system 100 may facilitate producing optical singularities for detecting and reconstructing inhomogeneities (e.g., density fluctuations and currents, etc.) in transparent and/or weakly-scattering propagation media. To continue the previous example, system 100 may facilitate reconstructing properties of a scattering medium such as perturbations from air currents or air pockets. As another example, system 100 may facilitate precision remote sensing of distant surfaces. To continue the previous example, system 100 may measure a displacement associated with a dark spot reflected of a vibrating surface (e.g., where the dark spot encodes information about surface vibrations, etc.). In some embodiments, system 100 may generate a physical structure to facilitate sensing characteristics such as tilt, displacement, thickness, color, and/or polarization associated with a beam and/or object. To continue the previous example, system 100 may generate a physical structure that correlates one or more of these sensing characteristics with the displacement of singular field structures, so that one or more precision measurements of the singular field structure shape and/or displacement provides qualitative or quantitative information about the correlated sensing characteristics.

In various embodiments, system 100 may be applied in quantum optics and/or communication. For example, system 100 may produce compact metasurface-enabled devices that generate red and blue-detuned atomic traps for quantum optics. Blue-detuned atomic traps are local minima in light intensity, which may be associated with optical singularities. As another example, system 100 may generate a physical structure to replicate random speckle patterns to defeat optical encryption (e.g., since speckle patterns may be optical singularity structures, etc.). As another example, system 100 may produce a physical structure to generate on-demand structured light for quantum communication (e.g., information can be encoded into modes including polarization singularities for mode-division multiplexed communication, thereby increasing communication bandwidth, etc.).

In various embodiments, system 100 may be applied in advanced holography. For example, system 100 may facilitate improved light/dark contrast in holograms (e.g., through selective placement of dark spots and/or extended dark structures, etc.). In various embodiments, system 100 may generate physical structures for application in acoustic and/or radiofrequency devices. For example, system 100 may generate a physical structure to shape radio-wave and/or acoustic-wave dead zones by manipulating emissions patterns produced by physical structure 10 or arising from field interactions with physical structure 10. As another example, system 100 may be used to produce/design a surface for an underwater structure and/or floating object to produce wave and/or acoustic singularities that reduce or enhance hydrodynamic resistance to motion.

In various embodiments, system 100 may applied to generate optical forces and/or perform debris accumulation. For example, system 100 may generate a physical structure to create an optical dark “shield” to repel particles from a region. As another example, system 100 may generate operational parameters to operate one or more devices to interact with a body of water to facilitate trash collection and/or oil spill concentration. As another example, system 100 may generate operational parameters for an acoustic transducer to facilitate particle trapping in acoustic singularities (e.g., for pollution filtration, etc.). In some embodiments, system 100 may generate/provide/define physical structures to determine a chirality of particles. For example, system 100 may generate a physical structure to facilitate chiral resolution of particles using optics (e.g., at the singularity boundary where the polarization response has the opposite sign, etc.). In various embodiments, physical structure 10 may be, include, and/or be associated with a “blue” atomic trap. In various embodiments, physical structure 10 may trap atoms in a dark spot and/or extended dark structure surrounded by light. It should be understood that, in various embodiments, “blue” atomic traps refer to 3D spatial confinement in which atoms are trapped in a dark spot and/or extended dark structure surrounded by light.

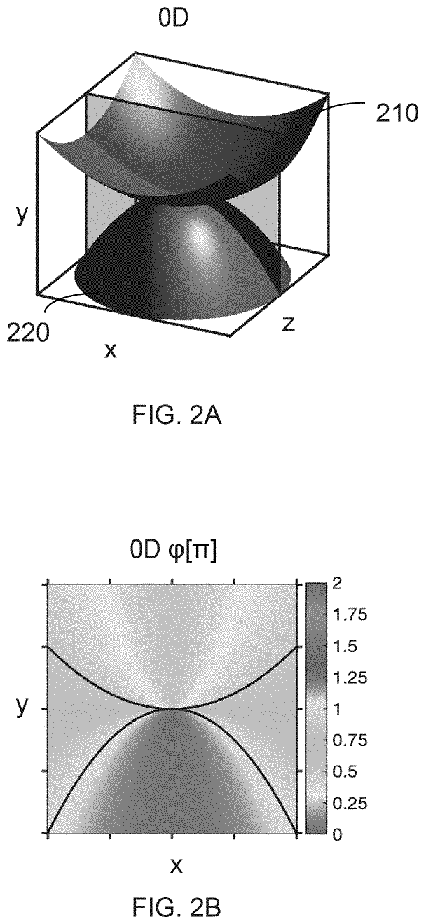

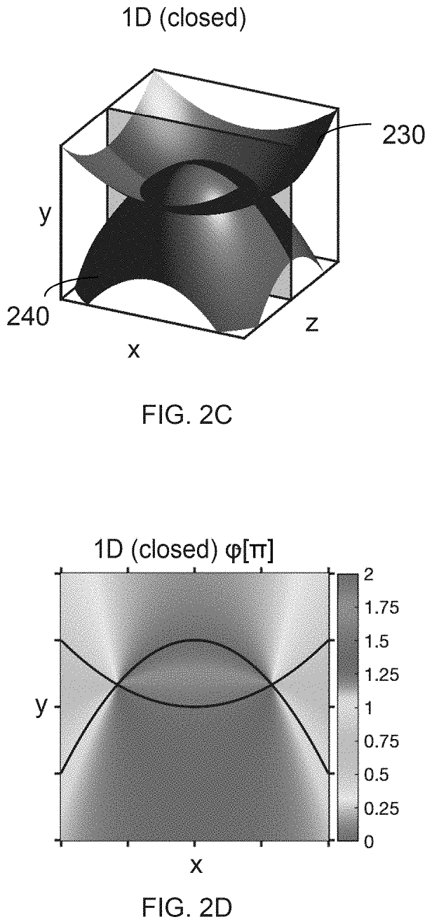

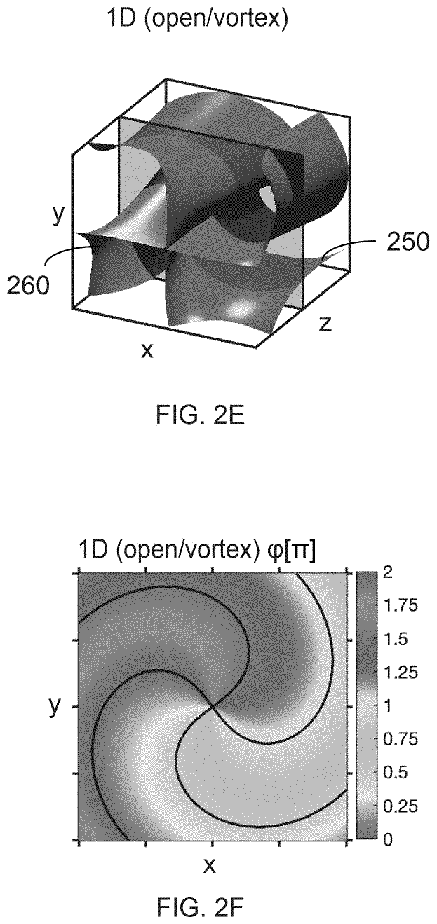

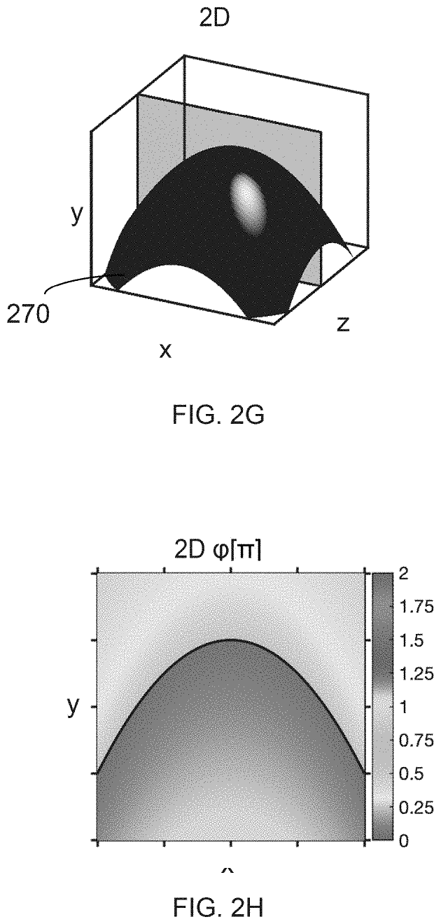

Turning now to FIGS. 2A-2H, a number of diagrams illustrating optical singularities are shown, according to several example embodiments. Singularities occur when one or more parameters of a field are undefined at one or more points. Phase singularities occur where real and imaginary parts of a scalar time-harmonic field E(r)=Re[E(r)]+iIm[E(r)] are simultaneously zero, thus leaving the overall phasefront undefined there. In most complex 3D scalar fields, the points at which the real (or imaginary) part of the field vanishes forms a 2D surface (a zero-isosurface). The field zeros and optical singularities thus occur at the intersection of these two zero-isosurfaces (Re[E(r)]=0 and Im[E(r)]=0). Referring to FIGS. 2A-B, the two field zero-isosurfaces (Re[E(r)]=0, shown as first surface 210, and Im[E(r)]=0, shown as second surface 220) intersect at exactly one point where the surfaces touch, forming a point 0D singularity, as shown in FIG. 2A. FIG. 2B illustrates the complex phase at an XY cross-section of the field in FIG. 2A. When the intersection between the two zero-surfaces forms a line, a 1D linear singularity is produced. By bringing the two surfaces (e.g., first surface 230 and second surface 240 as shown in FIG. 2C) that formed the 0D singularity in FIGS. 2A-2B closer together, the intersection locus becomes a closed loop, as shown in FIGS. 2C-2D. For the fundamental vortex beam, the real (e.g., first surface 250) and imaginary (e.g., second surface 260) parts only cross on the optical axis, as shown in FIGS. 2E-2F. FIGS. 2D and 2F illustrate cross-sections of these 1D singularities and demonstrate that the complex phase swirls in either a clockwise or anticlockwise fashion around the singularity locus. This swirling occurs because the two zero lines in the cross-sectional plane divide the plane into four quadrants with each combination of positive or negative real and imaginary field parts. In taking a loop around the singularity, one crosses into each of the four quadrants, accumulating a phase of ±π/2 over each quadrant to produce the characteristic phase swirl. When the real and imaginary zero-isosurfaces coincide, 2D sheet singularity 270 may be produced, as shown in FIGS. 2G-2H.

1D singular structures may differ from the other topologies in terms of their stability under field perturbations. For example, introducing a perturbation by adding a small nonzero complex number P to each of the scalar fields in FIGS. 2A-2H may be considered an additional plane wave in the long wavelength limit. To continue the example, the addition of P may displace and distort the zero-isosurfaces for at least one of the real and imaginary parts. For the 0D and 2D topologies, this shift may misalign the precise orientation of the zero-isosurfaces, destroying the singularity altogether (e.g., when the intersection is removed) or producing 1D singular lines (e.g., where the new isosurfaces intersect). In some embodiments, the addition of P to the 1D singularity fields causes the zero-isosurface intersection to be displaced in space, preserving the existence of the 1D singularity. 1D singularities are stable against such field perturbations, while 0D and 2D singularities may not be. 0D and 2D singularities are therefore exceedingly rare in random disordered optical fields. In various embodiments, the existence of a true mathematical 0D or 2D singularity relies on perfect alignment of field zero-surfaces. In various embodiments, optical fields may be engineered to behave in a manner which may closely approximate this behavior for practical purposes. This may also be the case for 3D singularities: although volumetric singularities may not be mathematically possible, “perfect” optical vortices with a dark hollow core can be designed and generated experimentally.

In some embodiments, design of optical devices to shape lighted regions of a field is possible through iterative techniques such as computer-generated holography, the Gerchberg-Saxton algorithm, or adjoint optimization, or through non-iterative means such as in guiding freestyle laser traps. These iterative light-shaping numerical techniques may rely on the reverse propagation of a desired light field distribution to provide information on how to improve the design of an optical device in the next iteration. Such techniques may work if the desired output optical shape comprises lighted regions but often fail if the desired pattern is dark or associated with little optical intensity. If there are singular regions in the desired optical output, reverse-propagation of the output from these regions may result in zero information provided to the iterative algorithm. Furthermore, computer-generated holography techniques may not work when the pattern is smaller than the diffraction-limited Airy disk spot size associated with the device aperture. Singularities are often closely associated with infinities in the spatial gradients of the field parameters that are singular. Therefore, a key to generating singularities as described herein lies not only in optimizing values of field parameters (such as phases), but also in configuring the spatial gradients of these field parameters. Phase singularities in particular are intimately connected to phase gradients, which rise to arbitrarily large values in the vicinity of a singularity. An infinite phase gradient at a point may imply that there is vanishing field value there, although the reverse implication is not always true.

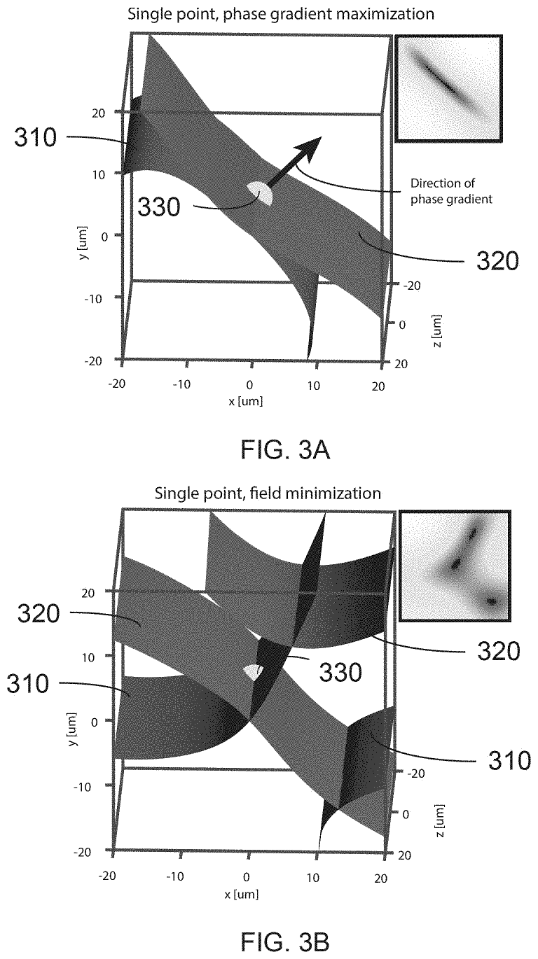

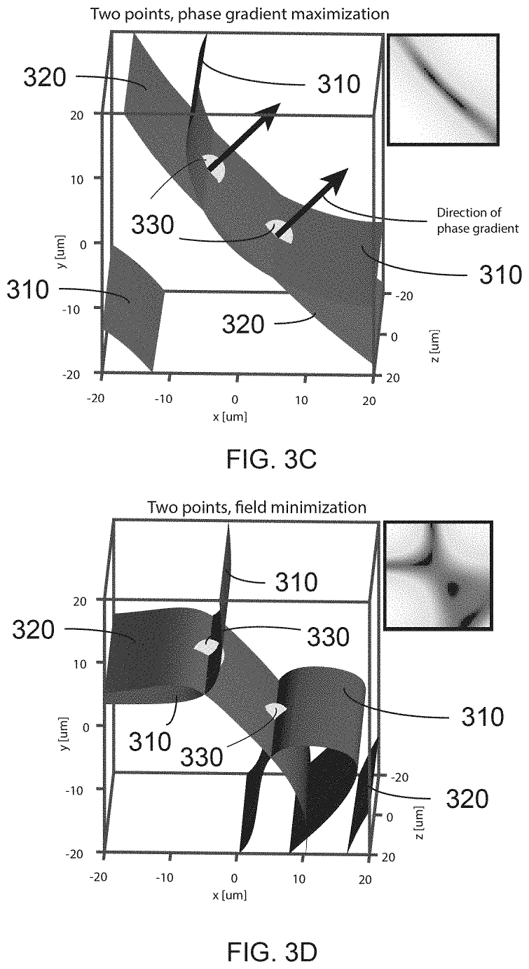

Turning now to FIGS. 3A-3D, field behavior in terms of real and imaginary zero-isosurfaces from optimization runs produced by phase gradient maximization and field minimization are illustrated, according to various example embodiments. Spheres 330 represent positions at which the field is optimized. Inset surface plots are the logarithmically scaled field intensities in the XY cross-section located at the middle z value of each 3D plot. In various embodiments, maximizing the phase gradient at a point in a specified direction may produce a sheet-like singularity (e.g., in a localized area, etc.), accompanied by a low intensity region. FIG. 3A illustrates the result of optimization for a single point (e.g., at the center of sphere 330). An asymptotically large and directed phase gradient can be achieved by aligning the real and imaginary zero-isosurfaces (surfaces 310 and 320, respectively) so that they touch tangentially and are normal to a specified direction, as shown in FIG. 3A. FIG. 3B illustrates a crossing of the zero-isosurfaces when the field amplitude is minimized at the center of sphere 330 instead, which may not produce sheet-like singularity behavior. A range of the sheet-like singularity may be extended by maximizing and/or increasing a phase gradient at multiple nearby positions, as shown in FIG. 3C. FIG. 3D illustrates multiple discrete intersections when the field amplitude is minimized at two points, which may not produce the desired sheet-like singularity behavior as shown in FIG. 3C. Phase gradient maximization may produce different field topologies than field amplitude minimization.

It should be understood that as used herein, “singularities” may refer to functional singularities that are close to and/or approaching “perfect” singularities as used in a mathematical sense.

Traditional systems using a finite difference method to estimate a derivative near singularities may be highly susceptible to errors (e.g., because of the associated a phase periodicity, etc.). System 100 may improve upon traditional systems by performing calculations and simulations on an algorithmic differentiation (backpropagation) platform (e.g., rather than using finite difference methods, etc.). In various embodiments, system 100 records the mathematical operations performed in connecting variables (such as device design parameters and their positions in space) to their results (such as complex field values or objective function values). System 100 may efficiently traverse this computational tree using the chain rule for derivatives to generate the numerical derivative of any calculated value with respect to another variable.

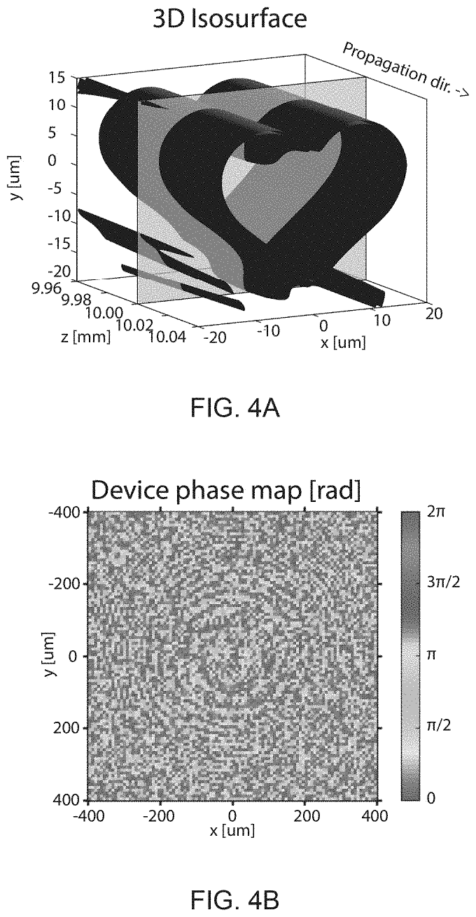

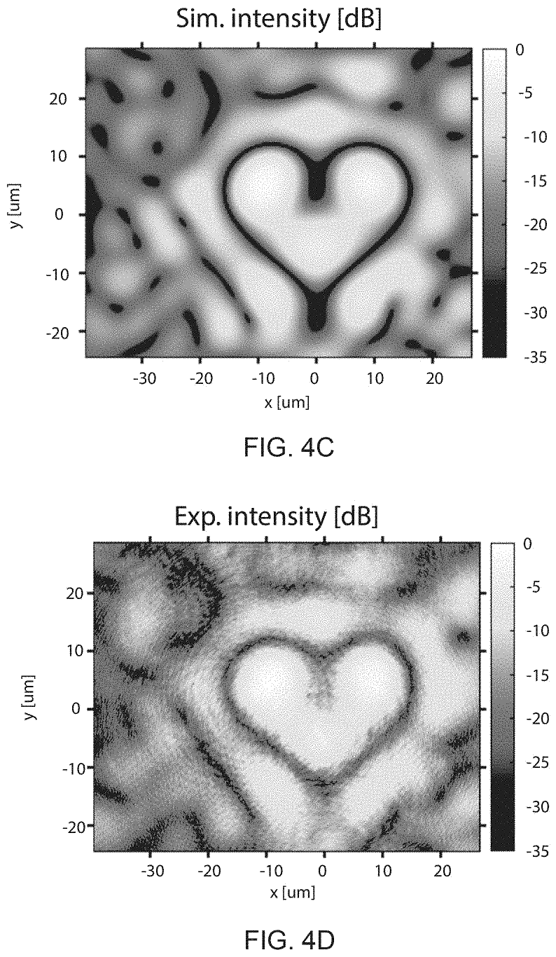

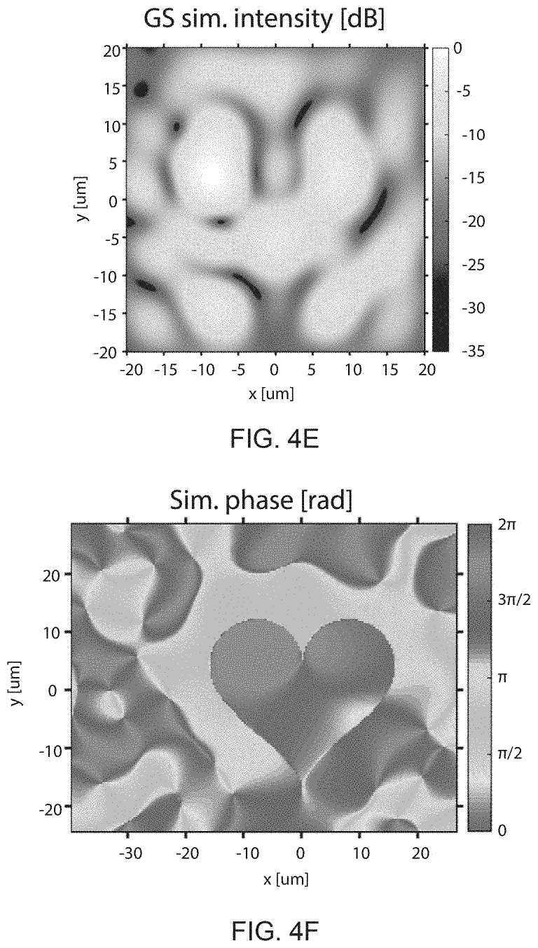

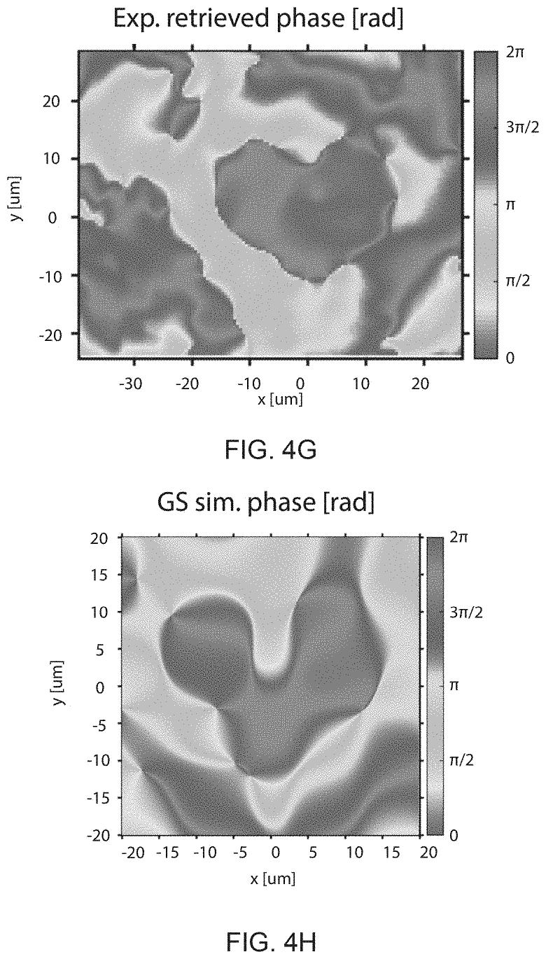

Referring now to FIGS. 4A-4H, a number of diagrams illustrating an optical phase singularity with an engineered cross-section in the shape of a heart are shown, according to an example embodiment. System 100 may produce singularities by gradient-descent optimization of a complex wavefront profile over a wavefront-controlling metasurface. Numerical predictions can be verified experimentally by fabricating metasurfaces (or any wavefront shaping device which can sample the highest spatial frequency of the target pattern) which enforce the required wavefront profile. System 100 may differ from existing systems and/or methods of deterministic singularity placement in that system 100 may not specify an analytical mathematical description of the field in the vicinity of the singularities, such as in the analytical construction of a superoscillating function to form an array of optical vortices or in constructing explicit analytic representations of the fields. Instead, system 100 may sculpt/define/establish singularities based on field gradients at the position of the singularity itself. Additionally or alternatively, system 100 may generate polarization singularities in analogy to phase singularities by maximizing the spatial gradient of polarization parameters at a singularity loci.

Referring now specifically to FIG. 4A, a 2D phase-singularity sheet with a cross-section in the shape of a heart is shown, according to an example embodiment. The singularity is designed for a scalar field at λ₀=532 nm emitted from a 0.8 mm×0.8 mm patterned square aperture placed 10 mm away from the target plane. The scalar field approximation (qualitatively supported by the target plane distance being much larger than the aperture size) is justified by a full vectorial propagation of the electromagnetic fields, which shows that the time-averaged energy density associated with the y (other transverse component) and z (axial) polarization components over the volume of interest is much smaller (in this case, less than 0.05%) that of the x-polarization. An isosurface plot of the simulated near-zero field intensity region may depict the orientation of the designed 2D singularity in 3D space. The grey-colored XY plane marked at z=10 mm (where z is the longitudinal coordinate) is the transverse plane over which the singularity phase gradient was optimized. A cross-sectional simulated intensity plot of the designed 2D singularity at this plane is shown in FIG. 4C.

FIG. 4F illustrates the simulated phasefront of the 2D heart-shaped phase singularity on the transverse plane at z=10 mm. There is a visible phase jump of π radians across the singularity boundary as the field changes sign. The phase profile is continuously differentiable with a well-defined phase gradient over the entire transverse plane, and achieves a large gradient value at the singularity boundary. In some embodiments, the transverse phase gradient |∇_{⊥}ϕ|²=(∂ₓϕ)²+(∂_{y}ϕ)² achieves large magnitudes near the heart-shaped boundary and may exceed the incident wavenumber k₀ by an order of magnitude, thereby exhibiting superoscillatory behavior.

In various embodiments, system 100 generates the 2D heart-shaped sheet singularity by maximizing a phase gradient in the directions oriented normally to the target heart-shape at the target z=10 mm plane. In other embodiments, system 100 may optimize the phase gradient in multiple z-planes. System 100 may generate/determine a physical structure to control the propagation phase delay (from 0 to 2π) at each pixel on a wavefront-controlling surface located at z=0 mm. In various embodiments, the physical structure forms/establishes a 2D singularity sheet. System 100 may partition the controlled surface (e.g., physical structure 10, etc.) into a 101×101 grid of square pixels with a pitch of 8 μm. In some embodiments, a pitch of the controlled surface matches that used by commercial spatial light modulators (SLMs). System 100 may parametrize the heart-shape at the target plane by 50 points and define the objective function to be maximized to be the minimum of the surface-normal phase gradients at those points. In some embodiments, the objective function of system 100 to be maximized may be the smooth approximation to the minimum of the surface-normal phase gradients. In various embodiments, system 100 performs optimization using gradient descent with iterative refinement. The optimized phase pattern is shown in FIG. 4B. In various embodiments, the optimized phase pattern does not exhibit any discernable long-scale pattern apart from a series of concentric rings which appear to have a focusing effect.

In various embodiments, the 2D sheet singularity can also be described as a collection of 1D singularities with integer topological charge placed in close proximity. For example, similar to optical vortices with fractional topological charge, the 2D singularity sheets described herein may be unstable with propagation, and may break apart into collections of optical vortices with topological charge m=±1 when the aligned zero-isosurfaces separate or cross each other. In some embodiments, the effective topological charge of the singularity sheet may be computed by taking the difference in topological charge computed along a larger heart-shaped contour that encircles the design curve and that from a smaller heart-shaped contour enclosed by the design curve. In some embodiments, this effective topological charge is computed to be −0.04. In some embodiments, local sheet-like behavior represents a finely-tuned relationship between adjacent stable optical vortices to produce sheet-like phase dislocations that comprise the singularity. In various embodiments, system 100 does not control individual trajectories of the component optical vortices. Additionally or alternatively, system 100 may control the trajectories of individual optical vortices. In various embodiments, system 100 optimizes over the total complex field to facilitate evolution of the vortices as needed to produce the desired overall singularity structure.

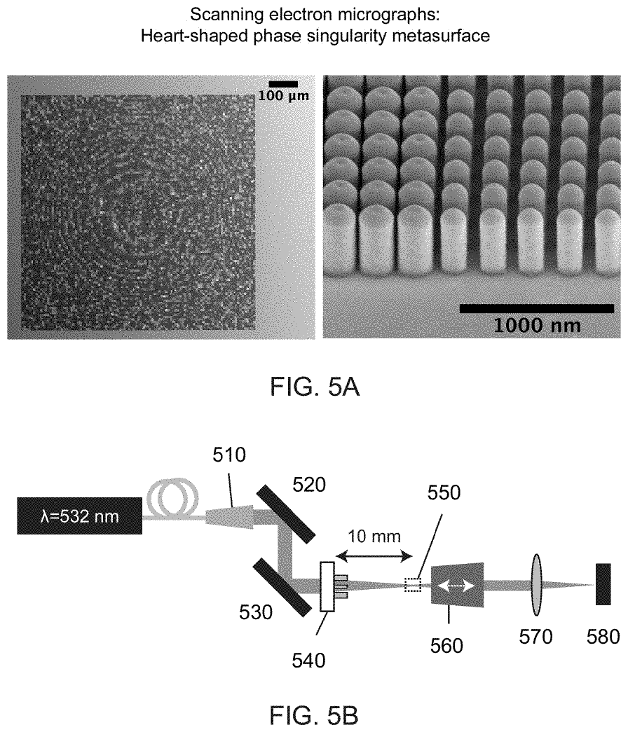

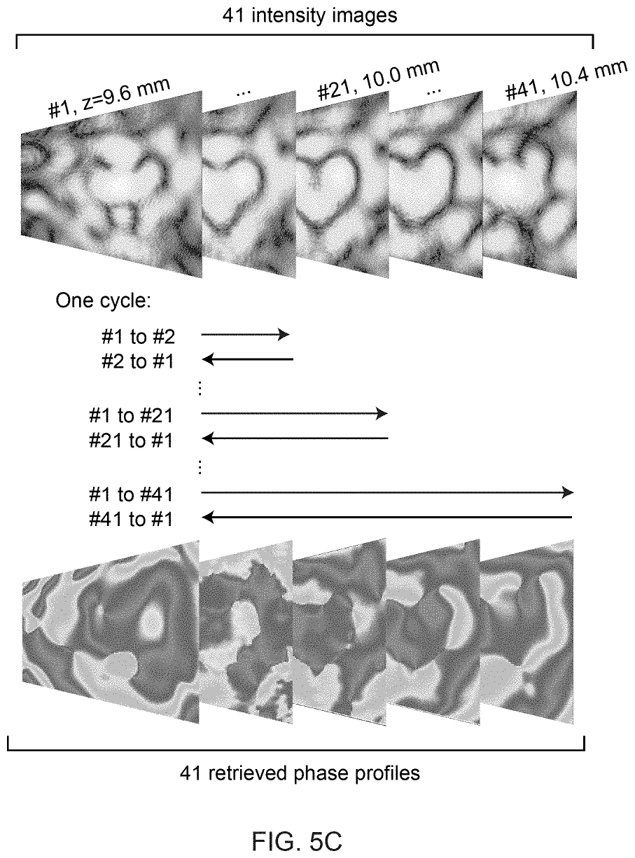

In various embodiments, system 100 may facilitate validating the numerical predictions described above by fabricating/producing the design of a transmissive metasurface that enforces the required phase profile described above in reference to FIG. 4B. The metasurface may include 600 nm-tall cylindrical pillars of TiO₂ on a fused silica substrate. In various embodiments, the metasurface includes 101×101 square superpixels with a pitch of 8 μm, where each superpixel comprises 32×32 subwavelength pixels with a single nanopillar each. However, it should be understood that the metasurface may have any number of elements such as nanopillars each having any configuration (e.g., pitch, size, shape, etc.). In other embodiments, the metasurface may comprise nanoholes of possibly varying pitch, size, shape, etc. In various embodiments, a diameter of the nanopillars controls the propagation phase delay imprinted onto transmitted light through the metasurface. FIG. 5A illustrates scanning electron micrographs of the full metasurface and the nanopillar arrays. FIG. 5B illustrates an experimental setup for profiling the singularity sheet produced. The setup may include fiber collimator 510, first mirror 520, second mirror 530, metasurface 540 (e.g., physical structure 10, etc.), heart-shaped phase singularity 550, objective 560 (e.g., a 100× objective with NA=0.95 on a stepper motor, etc.), lens 570 (e.g., a tube lens, etc.), and/or sensor 580 (e.g., a CMOS sensor, etc.). FIG. 5C illustrates single-beam multiple-intensity reconstruction applied to the 3D measured intensity map. FIGS. 4D and 4G illustrate intensity and reconstructed phase profiles produced by the metasurface at the z=10 mm plane, respectively. Both profiles exhibit close correspondence to those obtained through simulation as discussed in detail with reference to FIGS. 4C and 4F, respectively. In some embodiments, rapid intensity decay along the singularity sheet (˜−35 dB), stemming from the phase gradient maximization may be observed. The fidelity and continuity of such dark regions are difficult to replicate using conventional holography tools. For example, FIGS. 4E and 4G illustrate field intensity and phase obtained by using the Gerchberg-Saxton phase retrieval algorithm to design a similar heart-shaped singular trajectory just on one transverse plane, respectively. As the heart-shaped singular trajectory has features that are smaller than the characteristics size of features on the transverse plane, given by the Airy disk diameter of 11.5 μm in this case, conventional holography tools poorly replicate the desired field structure.

It should be understood that the systems and/or methods for producing 2D sheet phase singularities may also apply to producing 2D polarization singularity sheets. In various embodiments, system 100 generates C-point elliptic singularities, in which the polarization azimuth Ψ (in a paraxial field, with negligible longitudinal electric field contribution) is singular. Ψ is the angle that the major axis of the polarization ellipse makes with the transverse x-direction. The polarization azimuth may be calculated as 2Ψ=atan(s₂/s₁), where the Stokes parameters are, using the convention of positive left-handed circular polarization:

s₀=|Eₓ|²+|E_{y}|²

s₁=|Eₓ|²−|E_{y}|²

s₂=2Re(EₓE_{y}*)

s₃=2Im(EₓE_{y}*)

Together with the ellipticity angle 2θ=asin(−s₃/s₀), which determines the eccentricity and handedness of the polarization ellipse, the pair (Ψ, θ) parametrizes the space of fully-polarized light. On the Poincaré sphere, lines of constant Ψ are meridians that intersect at the North and South poles. Just as longitudes of the globe intersect at the poles so that the longitudinal coordinate is undefined at the poles, Ψ is singular at the poles of the Poincare sphere at which circularly polarized light resides. In analogy to phase singularities, system 100 may generate polarization singularities by maximizing the spatial gradient of where Ψ is the complex argument of the Stokes field Σ₁₂=s₁+is₂, which may play the analogous role of the complex scalar field over which singularities are defined. This complex field may exhibit the same geometries as discussed above in relation to FIGS. 2A-2H. System 100 may maximize the phase gradient of Σ₁₂, thereby maximizing the polarization azimuth gradient, and thereby producing a polarization singularity. At such a polarization singularity, s₁ and s₂ go to zero, in analogy to the vanishing of the real and imaginary parts of a scalar complex field at a phase singularity so that the polarization azimuth is undetermined. It should be understood however, that the overall field intensity at the polarization singularity may be non-zero because 53 may not vanish.

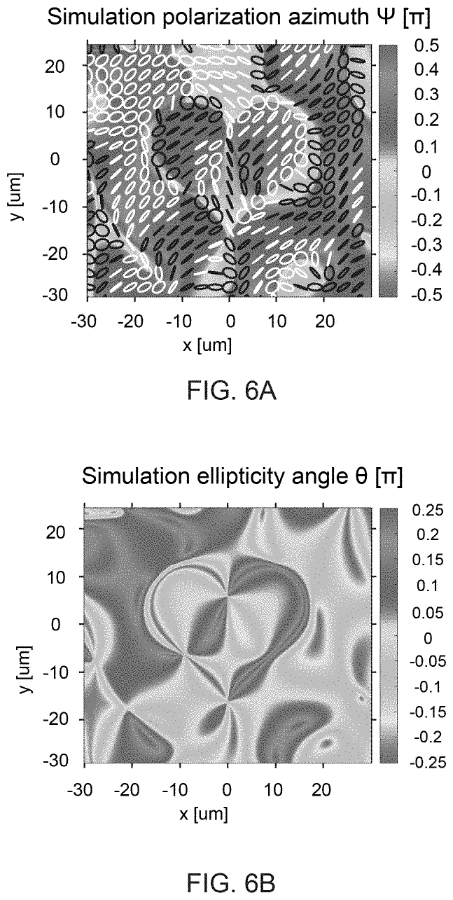

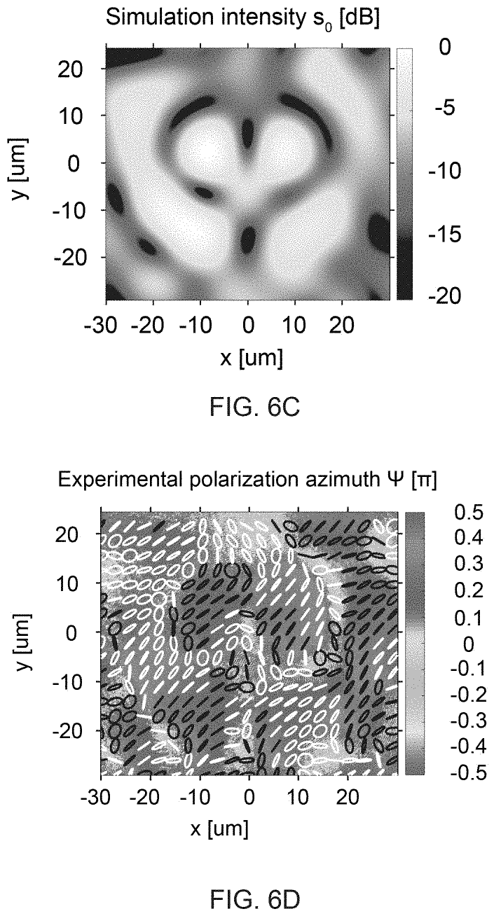

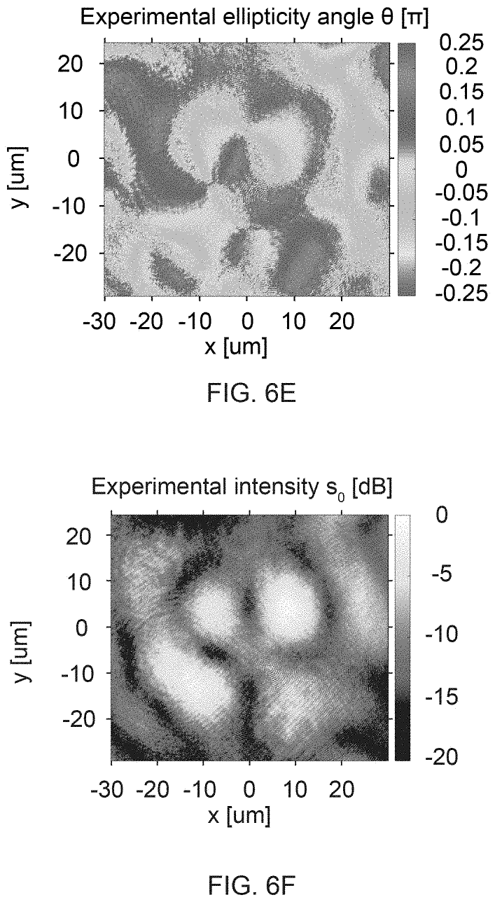

Referring now to FIGS. 6A-6F, a number of diagrams illustrating an engineered optical polarization singularity sheet with a cross-sectional jump in the polarization azimuth tracing the shape of a heart are shown, according to various example embodiments. The design heart-shape is similar to that of the phase singularity described above in reference to FIG. 4A-4D. In various embodiments, the heart-shaped singularity is centered at z=10 mm and is designed to be generated by a monochromatic plane wave at λ₀=532 nm incident on a patterned 0.4 mm×0.4 mm square aperture. In various embodiments, the incident plane wave is linearly polarized at an angle of 45° from the x-axis and is transmitted through a spatially variant waveplate placed at z=0 mm. The paraxial approximation (qualitatively supported by the target plane distance being much larger than the aperture size) is justified since the energy density associated with the longitudinal E_{z} in the volume of interest is much smaller (in this case, less than 0.05%) than that of the transverse Eₓ and E_{y} components. The polarization singularity field may be inverse designed over the retardance and diattenuation properties of the spatially variant waveplate. FIG. 6A illustrates the simulated spatially varying polarization azimuth (with local polarization ellipses superimposed) over the transverse plane at z=10 mm. FIGS. 6B-6C illustrate the ellipticity angle and field intensity on the same plane, respectively. In a similar manner to the heart-shaped phase singularity described above with reference to FIGS. 4A-4F, this heart-shaped polarization singularity extends into and out of the z=10 mm plane. It should be understood that FIG. 6A may illustrate a cross-section of a 2D polarization singularity sheet. The azimuth jump across the singularity may have a magnitude of π/2 because the complex argument of Σ₁₂ is twice the polarization azimuth Ψ. Additionally or alternatively, the polarization singularity may be illustrated by the transverse gradient of the polarization azimuth |∇_{⊥}Ψ| to show very rapid spatial variations which exceed the field wavenumber k₀.

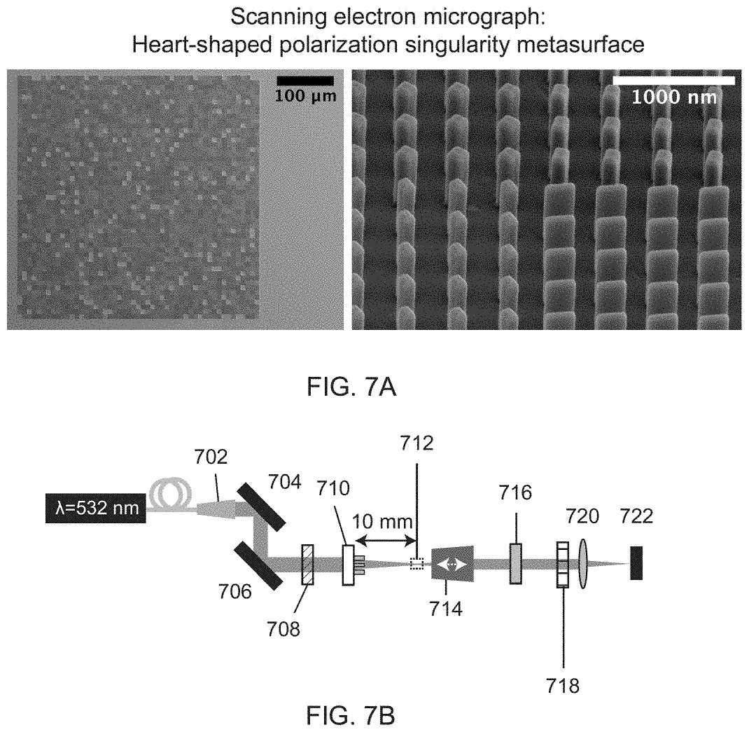

In various embodiments, system 100 produces a physical structure (e.g., physical structure 10, etc.) to control the spatial polarization variation of an optical wavefront, point-by-point. In some embodiments, the physical structure includes a spatially variant waveplate such as a polarization-sensitive metasurface. In some embodiments, physical structure 10 includes a phase-only spatial light modulator setup that structures and then superimposes two coherent beams with orthogonal polarizations. Transparent birefringent fins (meta-atoms) on a metasurface may behave locally as waveplates that perform a unitary transformation of the incident electric fields, thereby preserving the magnitude of the electric field upon transmission through the metasurface. System 100 may generate appropriate meta-atom geometries to cause the metasurface to behave as a spatially varying wave plate to control the polarization state of the field upon transmission. In various embodiments, the metasurface includes 51×51 square superpixels with a pitch of 8.4 μm, where each superpixel includes 20×20 subwavelength pixels with a single nanofin each. System 100 may generate design parameters for a metasurface using 600 nm-tall TiO₂ nanofins on a fused silica substrate. FIG. 7A illustrates micrographs of such a structure. FIG. 7B illustrates a setup to analyze the polarization singularity structures generated by the metasurface at z-positions around z=10 mm using rotating quarterwave plate polarimetry. The setup may include fiber collimator 702, first mirror 704, second mirror 706, polarizer 708 (e.g., a 45 degree polarizer, etc.), metasurface 710 (e.g., physical structure 10, etc.), heart-shaped phase singularity 712, objective 714 (e.g., a 100× objective with NA=0.95 on a stepper motor, etc.), quarterwave plate 716 (e.g., on a rotary stage, etc.), polarizer 718 (e.g., a horizontal polarizer, etc.), lens 720 (e.g., a tube lens, etc.), and/or sensor 722 (e.g., a CMOS sensor, etc.). FIGS. 6D-6F illustrate measurements of the polarization azimuth, ellipticity angle, and intensity at z=10 mm, respectively. These profiles exhibit close correspondence to those obtained through simulation as discussed in detail with reference to FIGS. 4A, 4B, and 4C, respectively.

In various embodiments, physical structure 10 may facilitate atomic trapping of neutral atoms using intensity gradients. Depending on the sign of the detuning Δ=ω−ω₀ between the optical trap field frequency ω and a strong atomic resonance frequency wo, neutral atoms are attracted to either intensity maxima (“red” Δ<0 detuning) or intensity minima (“blue” Δ>0 detuning). Optical dipole traps for cold atoms may be “red” traps which trap neutral atoms in arrays of tightly focused spots of light. System 100 may facilitate “blue” traps with 3D spatial confinement which may trap atoms in a dark spot surrounded by light. Conventional systems/methods may be unable to generate more than one “blue” trap with 3D spatial confinement.

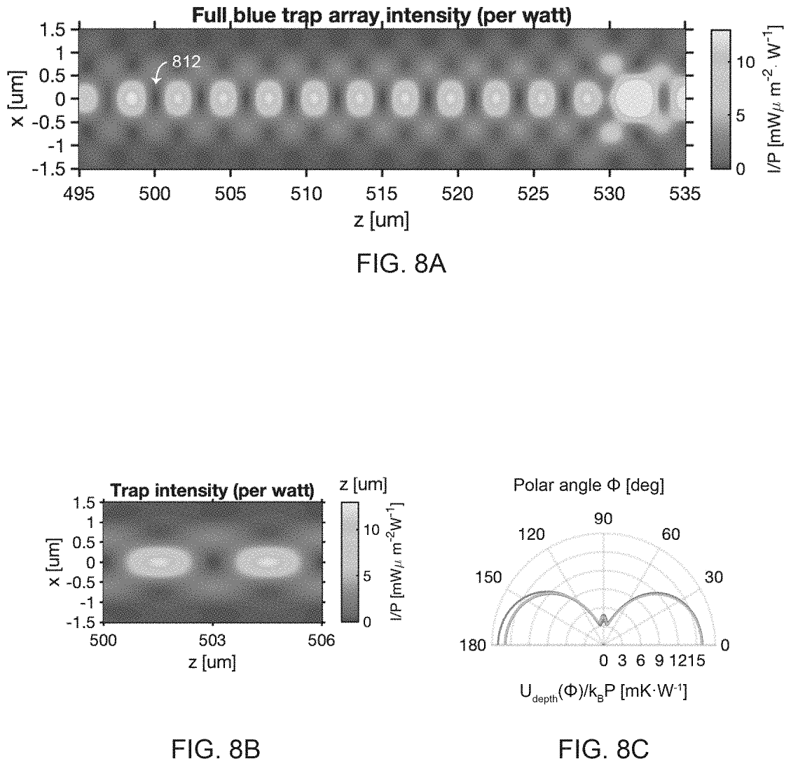

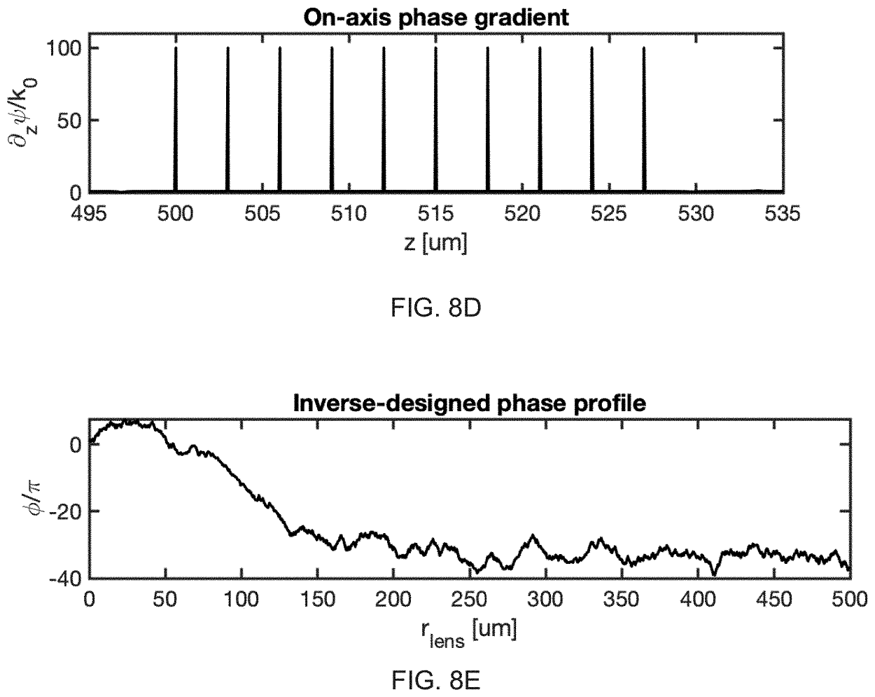

FIG. 8A illustrates a simulation of a linear array of ten identical blue traps 812 (λ₀=760 nm, blue-detuned from the D₂ line of Rubidium-87 at 780 nm) with a 1D array constant of 3 μm that can be generated from a single illuminating beam at z=0 This array includes periodically spaced zero-dimensional point singularities in the propagation direction. FIG. 8B illustrates an intensity profile around one of blue traps 812. FIG. 8C illustrates the maximum potential depth for a Rubidium-87 atom in each of the traps, as a function of the polar angle Φ from the z-directed optical axis. The potential depth U_{depth}(Φ) (in temperature units of mK) is the difference between the maximum potential height along angular direction and the dipole potential at the center of the trap. In various embodiments, the smallest trapping depth can reach 3 mK·W⁻¹ without any escape channels, indicating 3D spatial confinement for each trap.

The trap depth profile as a function of polar angle for each of the ten traps may be similar and the on-axis phase gradient can be 100 k₀ at the specified singularity positions, as shown in FIG. 8D. In various embodiments, this arises because the shape of the blue traps is mostly and/or fully identical from optimization, ensuring that each trap presents the same trapping potential. In some embodiments, the calculated radial trapping frequency is 25.0 kHz (P/[W])^{1/2} and the longitudinal trapping frequency is 291 kHz (P/[W])^{1/2}, with negligible variation between traps of less than 1 part per million (e.g., in simulation, etc.). FIG. 8E illustrates a metalens phase profile (unwrapped) that generates the blue-detuned array. In various embodiments, the profile is cylindrically symmetric and may include 1001 phase values (pitch 500 nm) within a 500 μm radius. In various embodiments, system 100 generates a nanopillar-based metasurface that enforces this required phase profile and produces a similar cross-sectional intensity profile.

In various embodiments, system 100 generates 2D sheet-like singularities by optimizing over a single transverse plane. In some embodiments, system 100 generates 2D sheet-like singularities by optimizing over multiple transverse planes. It should be understood that system 100 may be applied in various complex wave systems such as acoustic, fluidic, particle beam and plasmonic systems.

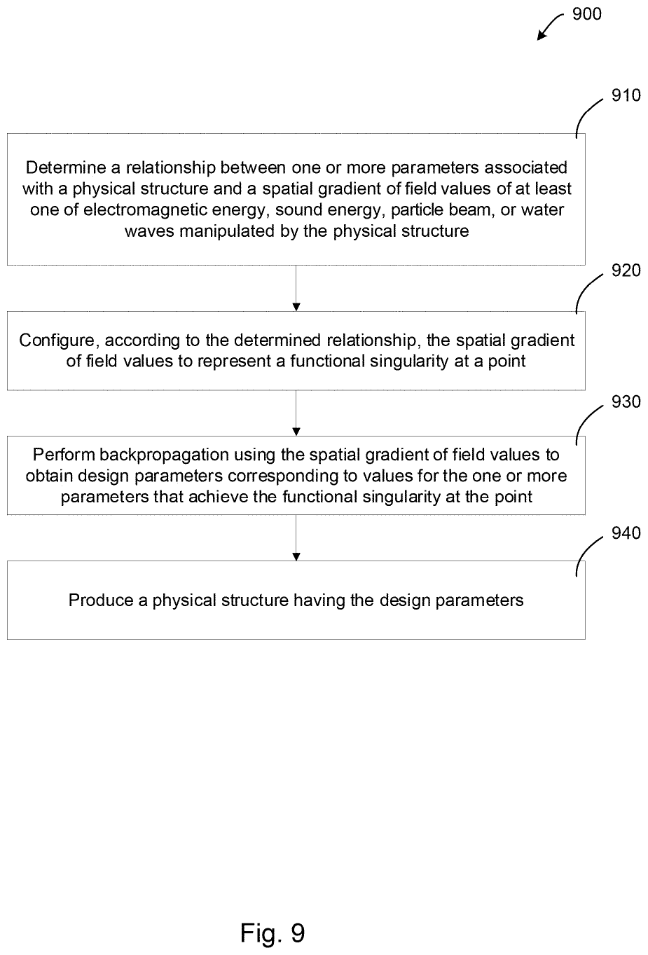

Turning now to FIG. 9, method 900 of generating a functional singularity is shown, according to an example embodiment. In various embodiments, system 100 performs method 900. At step 910, system 100 may determine a relationship between one or more parameters associated with a physical structure and a spatial gradient of field values of at least one of electromagnetic energy, sound energy, or water waves manipulated by the physical structure. In various embodiments, the field values are associated with light manipulated by the physical structure. In various embodiments, the relationship between parameters includes Green's function for wave propagation. Green's function may include an impulse response such as an impulse response of a linear differential operator. For example, Green's function G may be the solution of the equation LG=δ where δ is the Dirac delta function and L is the linear differential operator. Additionally or alternatively, the relationship between parameters may include a spatial Fourier transform to obtain far-field behavior.

At step 920, system 100 may configure, according to the determined relationship, the spatial gradient of field values to represent a functional singularity at a point. In various embodiments, the functional singularity includes a phase singularity in one or more field components. In some embodiments, the functional singularity includes a polarization singularity. For example, the polarization singularity may be in the azimuth of a transverse polarization. In some embodiments, configuring the spatial gradient of field values includes performing gradient descent optimization. In various embodiments, the functional singularity is associated with a maximized value of the spatial gradient of field values at the point. In various embodiments, the spatial gradient of field values at the point is oriented perpendicular to the singular structure.

At step 930, system 100 may perform backpropagation using the spatial gradient of field values to obtain design parameters corresponding to values for the one or more parameters that achieve the functional singularity at the point. In some embodiments, the design parameters include a plurality of nanostructure rotation angles. In some embodiments, the point is an isolated 0-dimensional position in 3-dimensional space. In some embodiments, a collection of points forms one or more 1-dimensional lines in 3-dimensional space. Additionally or alternatively, a collection of points may form one or more 2-dimensional surfaces in 3-dimensional space. Additionally or alternatively, a collection of points may form one or more 3-dimensional volumes in 3-dimensional space.

At step 940, system 100 may produce a physical structure having the design parameters. In various embodiments, the physical structure includes a metasurface. In some embodiments, the physical structure includes a spatially-variant phase plate. In some embodiments, the physical structure includes a spatial light modulator (SLM). In some embodiments, the physical structure includes a spatially-variant waveplate. Spatial variability may refer to a quantity that exhibits values that differ across different spatial locations. For example, a spatially-variant waveplate may describe a waveplate having different characteristics at various points on a 2-D surface of the waveplate. Additionally or alternatively, the physical structure may include an acoustic transducer. In some embodiments, the physical structure includes a water pump and/or pneumatic actuator. In some embodiments, the physical structure is a magnetic lens for particle beam deflection. In some embodiments, the physical structure is a shaped reflector or attenuator.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal to each other if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A method of generating a functional singularity at a point or collection of points, comprising:
determining a relationship between one or more parameters associated with a physical structure and a spatial gradient of field values of at least one of electromagnetic energy, sound energy, particle beam, or water waves manipulated by the physical structure;
configuring, according to the relationship, the spatial gradient of field values to represent a functional singularity at a point;
performing backpropagation using the spatial gradient of field values to obtain design parameters corresponding to values for the one or more parameters that achieve the functional singularity at the point; and
producing a physical structure having the design parameters.

2. The method of claim 1, wherein the functional singularity includes a phase singularity in one or more field components.

3. The method of claim 1, wherein the field values are associated with light manipulated by the physical structure and wherein the functional singularity includes a polarization singularity.

4. The method of claim 3, wherein the polarization singularity is in an azimuth or ellipticity angle of a transverse polarization.

5. The method of claim 1, wherein the physical structure includes a metasurface.

6. The method of claim 1, wherein the physical structure includes a spatially-variant phase plate.

7. The method of claim 1, wherein the physical structure includes a spatial light modulator (SLM).

8. The method of claim 1, wherein the physical structure includes a spatially-variant waveplate.

9. The method of claim 1, wherein the design parameters include a plurality of at least one of nanopillar diameter, height, or width values.

10. The method of claim 1, wherein the design parameters include a plurality of nanostructure rotation angles.

11. The method of claim 1, wherein the point includes an isolated 0-dimensional position in 3-dimensional space.

12. The method of claim 1, wherein the collection of points forms one or more 1-dimensional lines in 3-dimensional space and wherein the physical structure generates a functional singularity at the collection of points.

13. The method of claim 1, wherein the collection of points forms one or more 2-dimensional surfaces in 3-dimensional space and wherein the physical structure generates a functional singularity at the collection of points.

14. The method of claim 1, wherein the collection of points forms one or more 3-dimensional volumes in 3-dimensional space and wherein the physical structure generates a functional singularity at the collection of points.

15. The method of claim 1, wherein configuring the spatial gradient of field values includes performing gradient descent optimization.

16. The method of claim 1, wherein the functional singularity is associated with a maximized value of the spatial gradient of field values at the point.

17. The method of claim 1, wherein the spatial gradient of field values at the point is oriented perpendicular to the physical structure.

18. The method of claim 1, wherein the relationship between the one or more parameters associated with the physical structure and the spatial gradient of field values is associated with Green's function for wave propagation.

19. The method of claim 1, wherein the relationship between the one or more parameters associated with the physical structure and the spatial gradient of field values includes a spatial Fourier transform.

20. The method of claim 1, wherein the physical structure includes at least one of an acoustic transducer, a water pump, pneumatic actuator, or a magnetic lens.

21. The method of claim 1, wherein the physical structure traps atoms in at least one of a dark spot or an extended dark structure surrounded by light.
